(19) United States
(12) Patent Application Publication
(10) Pub. No.: US 2004/0097614 A1
(43) Pub. Date: May 20, 2004

(54) Composite materials from foundry waste

(76) Inventors: Adrian Merrington, Merrill, MI (US); Lowell S. Thomas, Midland, MI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 10/294,371

(22) Filed: Nov. 14, 2002

(51) Int. Cl. B22C 1/00; C08K 3/34

(52) U.S. Cl. 523/139; 524/443

(57) ABSTRACT

A composite material useful for fabricating useful articles from foundry industry by-products, while reducing environmental and economic burdens associated with current disposal practices in the foundry industry, includes a polymer matrix having foundry waste fines uniformly distributed throughout the matrix. Useful articles that can be fabricated from the composite materials of this invention include various high quality weights and counterweights, vibration dampers, sound absorbers, electrically conductive plastics, electromagnetic impulse shields, static dissipative articles and magnetic articles.

### FIELD OF THE INVENTION

This invention relates to composite materials and more particularly to filled plastic materials.

### BACKGROUND OF THE INVENTION

The disposal of foundry sands and residual inorganics results in a significant environmental and economic burden. The foundry industry in the United States disposes of approximately 12 billion pounds of spent sand and about 4 billion pounds of process residual fines annually. The annual cost for disposing of these materials is approaching 300 million dollars per year.

Foundries internally recycle sand from molds for multiple reuses. However, after a number of uses, the integrity of the sand is reduced and it can no longer be used to produce quality molds. The foundry industry has been researching disposal alternatives for spent foundry sand for decades. One class of residuals that is not currently recycled is the fines collected by dust collectors. Although the recycling of spent sand has been investigated and cost-effective alternatives to landfill have been implemented, the foundry industry recognizes a need for recycling the residual fines.

A significant and potentially useful component of these fines is iron. The residual iron fines can be readily separated by employing conventional magnetic separation techniques. However, the iron fines cannot be added to iron process furnaces because of the small size and low mass of the particles. The convective heat blasts from an iron processing furnace would carry the fines into the emission control system of the furnace. Processing the fines or binding the fines with adhesives to produce larger chunks that will not be carried by convective heat currents is relatively expensive. Further, such composites have tended to easily break down during processing. As a result, none of these processes has proven economically viable. Thus, the current practice is to landfill these fines. Sand-bentonite and residual iron-rich mixes contribute up to about 20% of the total materials disposed in landfills by the foundry industry, and represent a cost of about 72 million dollars per year.

Therefore, there is a need for useful articles prepared from materials comprising foundry waste fines, and methods of utilizing foundry waste fines for the production of useful articles, thereby eliminating or substantially reducing costs associated with disposal of foundry waste fines. It would be particularly desirable to provide useful articles comprised of foundry waste fines, wherein the articles exhibit a combination of properties superior to other materials currently used in certain applications.

### SUMMARY OF THE INVENTION

An objective of this invention is to recover economic value from foundry industry by-products and reduce environmental and economic burdens associated with current disposal practices in the foundry industry.

In accordance with an aspect of this invention, the objectives of the invention are achieved by the provision of an article formed from a composite material comprising a polymer matrix and foundry waste fines dispersed throughout the polymer matrix.

These and other features, advantages and objects of the present invention will be further understood and appreciated by those skilled in the art by reference to the following specification and claims.

### DESCRIPTION OF THE PREFERRED EMBODIMENTS

The composites of this invention generally comprise, consist essentially of, or consist of, as each of these expressions is normally interpreted, a polymeric or synthetic resin matrix, and foundry waste fines dispersed throughout the matrix. The polymeric or resin matrix may include a single synthetic polymer or a blend of two or more synthetic polymers, optionally containing various additives conventionally added to polymers and polymer blends, including adhesion promoters, antifogging agents, antimicrobial agents, antioxidants, antistatic agents, chelating agents, compatibilizers, flame retardants, lubricants, mold release agents, plasticizers, processing aids, colorants, etc. In addition to the foundry waste fines dispersed in the matrix, other fillers, extenders, and reinforcement agents may be added for particular applications.

The foundry waste fines used in the composite materials of this invention are waste by-products of the type which would otherwise be disposed of in a landfill. More specifically, during mechanical treatment processes used during recycling of foundry sand from foundry molds or cores, the used molds and cores are broken into smaller pieces or lumps, which are subsequently ground and/or subjected to other mechanical attrition intended to free up the individual grains of sand and remove binder residues. During this process, very small particles or fines are created. These fines are not recycled, but instead are removed for subsequent disposal. Typically, fines refer to particles having a size of about 250 microns or less.

Typically, foundry waste fines are comprised of silica (usually from about 30% to about 100% by weight), metal residue from where the casting or metal from the casting has contacted a sand mold or core (typically from about 0% to about 70% by weight), and relatively minor amounts of other materials such as residual polymer binder and/or degradation products of the binder (typically less than 1% by weight). The foundry waste fines may be used as collected, or may be subjected to further treatment. For example, for certain applications (e.g., high quality counterweights for office file cabinets) it may be desirable to utilize a high density filler material. In such case, the foundry waste fines may be subjected to magnetic separation, with the metallic component of the separation process being utilized as a high density filler material.

The foundry waste fines may also be subjected to size separation such as by use of sieves to provide a desired or optimum particle size distribution for a particular application. It may also be desirable to utilize a combination of both magnetic separation and size separation to obtain a particular particle size distribution and density or composition. Depending upon the source of the foundry waste fines, and factors such as the amount and type of metals contained in the foundry waste fines, the density of the foundry waste fines before treatment can range from about 2 to about 3 grams per cubic centimeter. After separation of the metal components from the raw foundry waste fines by magnetic separation, the resulting high metal stream typically has a density ranging from about 3 to about 7 grams per cubic centimeter.

The polymeric matrix may comprise one or more synthetic polymers or resins, which may either be virgin resins (i.e., relatively freshly synthesized resins which have never been used) or recycled resins. Examples of virgin resins which may be employed include polymers such as thermoplastic olefins (TPOs), high density polyethylene (HDPE), ethylene-(meth)acrylic acid copolymers (EAA), ethylene-ethyl acrylate (EEA) copolymers, ethylene-methylacrylate (EMA) copolymers and ethylene-vinyl acetate (EVA) copolymers. Examples of recycled polymeric materials which may be employed in the polymeric matrix include recycled ignition resistant acrylonitrile-butadiene-styrene terpolymers such as from discarded computer housings, recycled thermoplastics olefins (TPOs) such as from discarded vehicle bumper components, recycled high density polyethylene (HDPE) such as from discarded automotive interior components, recycled polyvinylbutyral (PVB) such as from discarded automotive wind screen interlayer material, recycled polystyrene (PS) such as from discarded casings for electronics, recycled polyvinylchloride (PVC) such as from discarded residential water pipe, recycled polymethylmethacrylate (PMMA) such as from discarded automotive lens covers, and recycled polypropylene (PP) such as from discarded automotive interior parts. The polymeric matrix may comprise one or more virgin resins and/or one or more recycled resins. In many cases, it will be desirable to utilize a matrix that is primarily comprised (e.g., more than 50% by weight), and as much as 100% by weight of recycled plastic materials in order to reduce raw material costs and to preserve the environment. The matrix material may also comprise a thermoset polymeric material (e.g., a cross-linked polymeric material), such as cross-linked phenolic, epoxy, polyester and polyurethane resins.

The amount of foundry waste fines (either raw foundry waste fines or a size or composition component obtained by separation of the raw foundry waste fines) added to the polymeric matrix depends on the particular application for the finished article. For example, the density of the composite can be adjusted as desired at any value from that of a pure resin up to more than two or three times the density of the polymeric matrix when the composite comprises about 10% of the polymeric matrix and about 90% of the high metal stream from a magnetic separation of raw foundry waste fines. Typically, the composites comprise from about 2% to 95% foundry waste fines by weight, and more commonly from about 50% to about 95% by weight. It has also been determined that excellent mechanical properties such as tensile strength and impact properties are possible even at relatively high loading levels of the foundry waste fines. Further, it has been determined that certain combinations of polymeric matrices and the unseparated, high or low metal component from a magnetic separation of foundry waste fines provide a composite material exhibiting good sound absorbing and mechanical vibration damping properties. In general, it appeared that lower levels of the low metal component of the foundry waste fines provided better sound absorbing and vibration damping properties with specific resin matrices. Further, it has been determined that certain combinations of polymeric matrices and the high metal component from magnetic separation of foundry waste fines provide a composite material with good electrical conductivity. In general, it appears that higher levels of the high metal component of foundry waste fines provided better electrical conductivity. A minimum of 75% by weight metals is required to obtain conductivity.

Formed articles comprising the composite materials of this invention may be prepared by extrusion, compression molding, injection molding, or generally any other forming technique commonly employed for preparing filled or reinforced plastic articles. The composites of this invention may also be formed into pellets, bars, sheets, etc., for subsequent molding or shaping operations, such as compression molding, thermoforming, casting etc.

A particular application for the composite materials of this invention is in the preparation of counterweights for file cabinets. File cabinets are typically fitted with counterweights to increase the stability of the unit when the drawers are open (i.e., to prevent tipping such as when a full or weighted top drawer of the file cabinet is fully open). Typically, these counterweights have been concrete or steel. An advantage of counterweights made from the composite materials of this invention is that they are more resistant to corrosion, chipping and cracking, easier to mold into more complex shapes, and in general have a better appearance. In general, the materials of this invention are useful in any of various applications in place of cast iron, concrete or steel weights and counterweights.

Another application for the composites of this invention is in vibration damping and sound absorption such as for vehicles and domestic appliances. In particular, it has been found that storage modulus and maximum Tan δ measurements indicate that high loadings of foundry waste fines provide damping properties. The more you add, the worse the dampening properties. However, even at high loadings in PVB there is still good damping but it is not improved.

The foundry waste fines, especially a high metal component thereof, may also be used to inpart electrical conductivity to a composite material.

The composites of this invention have also been found to exhibit electromagnetic impulse (EMI) shielding properties, static dissipative properties, and magnetic properties, suggesting their use in place of more expensive conventional EMI shielding materials, static dissipative materials, and magnetic materials.

Other potential applications include high-end decorative clock weights, slate replacement for billiard tables, speaker bases and enclosures, lawn tractor weights, microphone bases, fishing cannon balls, down-rigger weights, exercise equipment weights, mixer bases, television bases, patio tiles, and roofing tiles.

### EXAMPLES

The following examples illustrate the invention, but do not limit the scope thereof.

Contaminant Analysis by GC-MS

Gas Chromatography-Mass Spectrometry (GC-MS) analysis was used to identify possible binder residuals in the foundry fines. Approximately, 0.5 grams of each sample was weighed into respective 5 mL vials. A 1 cm³ aliquot of methylene chloride was added to each and they were shaken on a wrist action shaker for 30 minutes to extract possible binders from the sand. Initial shaking of 5 minutes proved insufficient for the majority of the samples. After shaking, the sample was allowed to settle to the bottom prior to decanting the dosed methylene chloride to GC autosampler vials for analysis.

Extracts were analyzed on a Hewlett Packard Model 6890 series GC with 5973 mass selective detector (MSD). The following system conditions used are reported in Table 1.

TABLE 1
Experimental conditions for GPC-MS analysis of fines

| | |
|---|---|
| Column | HP-1 30 m 0.25 mm × 1.0 micron film |
| Oven | 50° C. to 300° C. @ 10° C./min, hold 5 min |
| Inlet | 1 μL split 50:1 @ 260° C. |
| Transition line | 280° C. |
| MSD | Scan 35-700 m/z |

Components were identified with the use of an NIST 98 mass spectral search database and are thus tentative. The results of these analyses are reported in Table 2.

TABLE 2
Organic signatures determined by GPC-MS
analysis of foundry fines

| Foundry | High Metals | Low Metals |
|---|---|---|
| 1 | Parts per million | Parts per million |
| | methyl isobutyl ketone | methyl isobutyl ketone |
| | 1-ethyl-4-methyl-benzene | 1,3,5-Trimethylbenzene |
| | 1-ethyl-3-methyl-benzene | 1-ethyl-2-methylbenzene |
| | 1,3,5-trimethylbenzene | 1,2,3-trimethylbenzene |
| | 1-ethyl-2-methylbenzene | 1-ethyl-3-methylbenzene |
| | 1,2,4-trimethylbenzene | 1-ethyl-2,3-dimethylbenzene |
| | 2-methylnaphthalene | undecane |
| | tetradecane | naphthalene |
| | heptadecane | dodecane |
| | undecane | |
| | naphthalene | |
| | dodecane | |
| 2 | NOT ENOUGH MATERIAL | Parts per thousand |
| | AVAILABLE | toluene |
| | TO COLLECT A SAMPLE | styrene |
| | | phenol |
| | | 1,3,5-trimethylbenzene |
| | | naphthalene |
| | | 2-ethenyl naphthalene |
| | | or biphenyl diphenylmethane |
| | | 3-methyl-1,1′-biphenyl |
| | | anthracene |
| 3 | Parts per million | Parts per million |
| | 1-ethyl-3-methylbenzene | methyl isobutyl ketone |
| | 1,3,5-trimethylbenzene | 1-ethyl-3-methylbenzene |
| | 1-ethyl-4-methylbenzene | 1,3,5-trimethylbenzene |
| | 1,2,4-trimethylbenzene | 1-ethyl-4-methylbenzene |
| | 1,2,3-trimethylbenzene | 1,2,4-trimethylbenzene |
| | 1-methylpropylbenzene | 1,2,3-trimethylbenzene |
| | 2-ethyl-1,4-dimethylbenzene | 1-methylpropylbenzene |
| | tetradecane | 2-ethyl-1,4-dimethylbenzene |
| | pentadecane | tetradecane |
| | | pentadecane |
| 4 | Parts per million | Parts per million |
| | methyl isobutyl ketone | methyl isobutyl ketone |
| | toluene | toluene |
| | 1-ethyl-3-methylbenzene | 1-ethyl-3-methylbenzene |
| | 1,3,5-trimethylbenzene | 1,3,5-trimethylbenzene |
| | 1-ethyl-4-methylbenzene | 1-ethyl-4-methylbenzene |
| | 1,2,4-trimethylbenzene | 1,2,4-trimethylbenzene |
| | 1,2,3-trimethylbenzene | 1,2,3-trimethylbenzene |
| | 1-methylpropylbenzene | 1-methylpropylbenzene |
| | 2-ethyl-1,4-dimethylbenzene | 2-ethyl-1,4-dimethylbenzene |
| | 4-ethyl-1,2-dimethylbenzene | 4-ethyl-1,2-dimethylbenzene |
| | 1,2,3,4-tetramethylbenzene | 1,2,3,4-tetramethylbenzene |
| | 1,2,3,5-tetramethylbenzene | 1,2,3,5-tetramethylbenzene |
| | naphthalene | naphthalene |
| | tetradecane | tetradecane |
| | hexadecane | |
| | heptadecane | |
| | octadecane | |
| 5 | Parts per million | Parts per million |
| | 1-ethyl-3-methylbenzene | methyl isobutyl ketone |
| | 1,3,5-trimethylbenzene | 1-ethyl-3-methylbenzene |
| | 1-ethyl-4-methylbenzene | 1,3,5-trimethylbenzene |
| | 1,2,4-trimethylbenzene | 1-ethyl-4-methylbenzene |
| | 1,2,3-trimethylbenzene | 1,2,4-trimethylbenzene |
| | | 1,2,3-trimethylbenzene |
| | | 1-methylpropylbenzene |
| | | 2-ethyl-1,4-dimethylbenzene |
| 6 | Parts per million | Parts per million |
| | methyl isobutyl ketone | methyl isobutyl ketone |
| | phenol | phenol |
| | 1-ethyl-3-methylbenzene | 1-ethyl-3-methylbenzene |
| | 1,3,5-trimethylbenzene | 1,3,5-trimethylbenzene |
| | 1-ethyl-4-methylbenzene | 1-ethyl-4-methylbenzene |
| | 1,2,4-trimethylbenzene | 1,2,4-trimethylbenzene |
| | 1,2,3-trimethylbenzene | 1,2,3-trimethylbenzene |
| | 1-methyl-3-propylbenzene | 1,2,4,5-tetramethylbenzene |
| | 1-ethyl-2,4-dimethylbenzene | 1,2,3,5-tetramethylbenzene |
| | 1,2,4,5-tetramethylbenzene | naphthalene |
| | 1,2,3,5-tetramethylbenzene | 3-phenoxy-1-propanol |
| | naphthalene | 2-methylnaphthalene |
| | 3-phenoxy-1-propanol | |
| | 2-methylnaphthalene | |
| | 2,2′-methylenebis-phenol | |
| | 4,4′-methylenebis-phenol | |

Analysis was qualitative rather than quantitative. However, the ease with which contaminants were extracted and knowledge of the process may be used as an indication of the relative quantities of contaminants present. Most of the samples are contaminated at the parts per million levels. The single exception was in the low metals sample from foundry 2 that had significantly higher quantities of residuals; probably at the parts per thousand level.

The trace quantities of chemicals identified here do not indicate health hazards associated with using these materials. A previous analysis, shown in Table 3, confirms that these streams are efficacious recycle streams and that all levels are significantly lower than the TCLP regulatory limits (shown below).

TCLP Regulatory Limits

Arsenic 5.0 mg/L

Barium 100.0 mg/L

Cadmium 1.0 mg/L

Chromium 5.0 mg/L

Lead 5.0 mg/L

Mercury 0.2 mg/L

Selenium 1.0 mg/L

Silver 5.0 mg/L

TABLE 3
TCLP and pH analysis of foundry fines by
TriMatrix Laboratories, Inc.

| Foundry | Results |
|---|---|
| 1 | Arsenic <0.20 mg/L (below test limit) |
| | Barium 0.63 (test limit 0.20 mg/L) |
| | Cadmium <0.01 mg/L (below test limit) |
| | Chromium <0.08 mg/L (below test limit) |
| | Lead <0.10 mg/L (below test limit) |
| | Mercury <0.0004 mg/L (below test limit) |
| | Selenium <0.20 mg/L (below test limit) |
| | Silver <0.01 mg/L (below test limit) |
| | pH 8.19 |
| 2 | Arsenic <0.20 mg/L (below test limit) |
| | Barium 0.41 (test limit 0.20 mg/L) |
| | Cadmium <0.01 mg/L (below test limit) |
| | Chromium <0.08 mg/L (below test limit) |
| | Lead <0.10 mg/L (below test limit) |
| | Mercury <0.0004 mg/L (below test limit) |
| | Selenium <0.20 mg/L (below test limit) |
| | Silver <0.01 mg/L (below test limit) |
| | pH 3.89 |
| 3 | Arsenic <0.20 mg/L (below test limit) |
| | Barium 0.63 (test limit 0.20 mg/L) |
| | Cadmium <0.01 mg/L (below test limit) |
| | Chromium <0.08 mg/L (below test limit) |
| | Lead <0.10 mg/L (below test limit) |
| | Mercury <0.0004 mg/L (below test limit) |
| | Selenium <0.20 mg/L (below test limit) |
| | Silver <0.01 mg/L (below test limit) |
| | pH 8.19 |
| 4 | Arsenic <0.20 mg/L (below test limit) |
| | Barium 0.57 (test limit 0.20 mg/L) |
| | Cadmium <0.01 mg/L (below test limit) |
| | Chromium <0.08 mg/L (below test limit) |
| | Lead <0.10 mg/L (below test limit) |
| | Mercury <0.0004 mg/L (below test limit) |
| | Selenium <0.20 mg/L (below test limit) |
| | Silver <0.01 mg/L (below test limit) |
| | pH 8.39 |
| 5 | Arsenic <0.20 mg/L (below test limit) |
| | Barium 0.53 (test limit 0.20 mg/L) |
| | Cadmium 0.016 mg/L (below test limit) |
| | Chromium <0.08 mg/L (below test limit) |
| | Lead <0.10 mg/L (below test limit) |
| | Mercury <0.0004 mg/L (below test limit) |
| | Selenium <0.20 mg/L (below test limit) |
| | Silver <0.01 mg/L (below test limit) |
| | pH 10.47 |

Plastic Characterization

The virgin materials were chosen as they are typically used to produce the parts that form the source of the recycle streams employed in this program. They may not, however, be identical resins and were included primarily for comparison purposes. It is important to recognize that there may be significant differences between the mechanical properties of the resins used to produce the parts that form the recycle streams employed in this program and the corresponding virgin materials. The mechanical properties of these plastics are shown in Table 4. The results were typical of the plastics tested and were as expected.

TABLE 4
Mechanical properties of base plastics used as binders in this program

| | Yield | Break | Yield | Elongation | | Break | Impact | |
|---|---|---|---|---|---|---|---|---|
| | Stress | Stress | Strain | at Break | Modulus | Energy | Strength | Fracture |
| Material | (psi) | (psi) | (%) | (%) | (kpsi) | (lbf · in) | (ft · lb/in) | Mode |
| Recycle PVB | No | >1300 | No | >195 | 0.3 | >5.7 | No break | N/A |
| Strategic Materials | yield | | yield | | | | | |
| source | | | | | | | | |
| Virgin ABS (ir) | 5400 | 4700 | 2.3 | 50 | 320 | 300 | 3.2 | H |
| Dow | | | | | | | | |
| Magnum 4435 | | | | | | | | |
| Recycle ABS (ir) | 4200 | 4100 | 1.8 | 18 | 320 | 8.1 | 0.9 | C |
| RPI source | | | | | | | | |
| Virgin HDPE | 3800 | 1950 | 9.0 | >785 | 290 | 1.1 | 1.1 | C |
| Eastman Chemical | | | | | | | | |
| Tenite H6001 | | | | | | | | |
| Recycle HDPE | 3450 | 2100 | 10.0 | 30 | 150 | 315 | 1.5 | C |
| ACi source | | | | | | | | |
| Virgin TPO | 2800 | 1900 | 8.9 | 170 | 125 | 460 | 12.1 | NB |
| Solvay | | | | | | | | |
| Sequel 1440 | | | | | | | | |
| Recycle TPO | 2800 | 2400 | 5.7 | 53 | 135 | 165 | 6.4 | H |
| ACi source | | | | | | | | |

Fracture mode results detail
C complete break,
H hinge break,
NB no break,
N/A Not applicable.

Composite Characterization

Characterization provided some insight into possible applications for the composites.

Mechanical Properties

Tensile testing was performed to the specifications set in ASTM D638. Tensile testing was performed on a Zwick Materialprufung 1455 tensile machine at a crosshead speed of 20 inches per minute. The notched Izod impact testing was performed using a Baldwin impact tester and followed the procedure set by ASTM D256.

The notched impact analysis of a concrete block was performed for comparison purposes. A test coupon for tensile analysis could not be machined. Although values could not be recorded experimentally, simple manual manipulation of the materials revealed that the small concrete parts were, as expected, brittle and would have minimal elongation properties. The impact properties of concrete, as tested using the ASTM standard developed for plastic (ASTM D256), is recorded in Table 5.

TABLE 5
Notched Izod impact strength of concrete and steel measured
following the specifications described in plastic ASTM D256

| Material | Izod Impact (ft · lb/in) | Fracture Mode* |
|---|---|---|
| Concrete | 0.16 | C |
| Steel | NB | NB |

Fracture mode results detail C complete break, H hinge break, NB no break, N/A Not applicable.

A similar test coupon that was made from steel was obtained. The impact properties of steel, as tested using the ASTM standard developed for plastic (ASTM D256), is also recorded in Table 5.

Low Metallics Composites

The results shown in Table 6 revealed that there was little difference between using virgin or recycle plastics. Both virgin and recycle HDPE binder produced parts with significantly better mechanical properties than concrete.

TABLE 6
Tensile and impact properties of low metallic/plastic composites

| | | | Yield | Break | Yield | Elongation | | Break | Izod | |
|---|---|---|---|---|---|---|---|---|---|---|
| | | % | Stress | Stress | Strain | at Break | Modulus | Energy | Impact | Fracture |
| Filler | Binder | Solids | (psi) | (psi) | (%) | (%) | (kpsi) | (lbf · in) | (ft · lb/in) | Mode*** |
| Low Metals | Virgin HDPE | 25 | 4300 | 4300 | 3.3 | 3.3 | 330 | 12.3 | 0.64 | c |
| Low Metals | Virgin HDPE | 50 | 4000 | 4000 | 1.8 | 1.8 | 480 | 6.6 | 0.56 | c |
| Low Metals | Virgin HDPE | 75 | 3200 | 3200 | 0.6 | 0.6 | 870 | 2.0 | 0.48 | c |
| Low Metals | Virgin HDPE | 80 | 1400 | 40 | 0.0 | 0.0 | 1100 | 0.2 | 0.63 | c |
| Low Metals | Recycle HDPE | 25 | 3900 | 3900 | 6.0 | 6.5 | 270 | 24.6 | 1.06 | c |
| Low Metals | Recycle HDPE | 50 | 2600 | 2600 | 0.9 | 0.9 | 360 | 2.0 | 0.67 | c |
| Low Metals | Recycle HDPE | 75 | 4000 | 4000 | 1.0 | 1.0 | 720 | 3.9 | 0.68 | c |
| Low Metals | Recycle HDPE | 80 | 3000 | 3000 | 0.5 | 0.5 | 720 | 1.8 | 0.65 | c |
| Low Metals | Recycle HDPE | 85 | 1700 | 1700 | 0.2 | 0.2 | 740 | 0.5 | 0.76 | c |
| Low Metals | Recycle TPO* | 25 | 2200 | 2100 | 2.0 | 3.0 | 270 | 7.3 | 1.08 | c |
| Low Metals | Recycle TPO* | 50 | 2100 | 2100 | 1.5 | 2.2 | 370 | 5.3 | 0.73 | c |
| Low Metals | Recycle TPO* | 75 | 1725 | 1725 | 0.8 | 0.8 | 350 | 1.5 | 0.64 | c |
| Low Metals | Recycle TPO* | 80 | 1300 | 1300 | 0.6 | 0.6 | 240 | 0.8 | 0.72 | c |
| Low Metals | Recycle TPO** | 25 | 2500 | 2500 | 3.4 | 4.8 | 230 | 12.3 | 0.93 | c |
| Low Metals | Recycle TPO** | 50 | 2000 | 2000 | 1.4 | 1.4 | 270 | 2.6 | 0.63 | c |
| Low Metals | Recycle TPO** | 75 | 1900 | 1900 | 1.1 | 1.1 | 360 | 3.6 | 0.72 | c |
| Low Metals | Recycle TPO** | 80 | 2000 | 1900 | 1.0 | 1.5 | 390 | 4.4 | 0.76 | c |
| Low Metals | Recycle ABS | 25 | 4200 | 4200 | 1.3 | 1.3 | 490 | 4.9 | 0.64 | c |
| Low Metals | Recycle ABS | 50 | 3200 | 3200 | 0.5 | 0.5 | 710 | 1.4 | 0.60 | c |
| Low Metals | Recycle ABS | 75 | 3500 | 3500 | 0.3 | 0.3 | 1100 | 1.6 | 0.48 | c |
| Low Metals | Recycle ABS | 80 | 2000 | 2000 | 0.2 | 0.2 | 1400 | 0.5 | 0.52 | c |
| Low Metals | Recycle PVB | 15 | 1800 | 1800 | 110 | 110 | 1 | 60 | 10.96 | h |
| Low Metals | Recycle PVB | 25 | 1300 | 1300 | 110 | 110 | 1 | 105 | 11.00 | h |
| Low Metals | Recycle PVB | 33.3 | 1300 | 1200 | 95 | 95 | 1 | 125 | 8.76 | h |
| Low Metals | Recycle PVB | 35 | 1300 | 1200 | 75 | 85 | 2 | 120 | 8.84 | h |
| Low Metals | Recycle PVB | 50 | 1520 | 1480 | 25 | 25 | 14 | 40 | 2.72 | h |
| Low Metals | Recycle PVB | 66.6 | **** | **** | **** | **** | **** | **** | 1.00 | c |

*Paint,
**No Paint.
***Fracture mode results detail C complete break, H hinge break, NB no break, N/A Not applicable.
****Sample too viscous to mold to test specifications.

At lower concentrations, the TPO recycle that had paint contamination removed had better mechanical properties than TPO recycle that had not had the paint removed. This was as expected. At higher concentrations of fines, there was little difference between the composites using the two TPO binders.

High solids content ABS binder composites were very viscous and hard to mold. The recycle ABS used may have had too high a viscosity for this application.

As recorded earlier, PVB did not accept the low metallic fines as well as expected. PVB typically has excellent wetting out properties (as evidenced by its interaction with high metallic fines streams). It appears that there may be some chemical or physical interaction occurring between the PVB and the low metallic fines stream. The low metallic fines stream used here was the one that subsequent experiments revealed had the highest concentration of additives. These additives may also contribute to the chemical or physical interactions with the PVB binder.

High Metallics Composites

The plastics accepted more of the high metallic fines than low metallic fines. This was not surprising given the density differences of the two fines components. Composites comprising up to 93% w/w high metallic fines were not difficult to compound. The mechanical properties of some of these compounds are shown in Table 7.

TABLE 7
Tensile and impact properties of high metallic/plastic composites

| | | | Yield | Break | Yield | Elongation | | Break | Izod | |
|---|---|---|---|---|---|---|---|---|---|---|
| | | % | Stress | Stress | Strain | at Break | Modulus | Energy | Impact | Fracture |
| Filler | Binder | Solids | (psi) | (psi) | (%) | (%) | (Kpsi) | (lbf · in) | (ft · lb/in) | Mode*** |
| High Metals | Virgin HDPE | 50 | 3300 | 3300 | 2.1 | 2.1 | 390 | 6.6 | 0.68 | c |
| High Metals | Virgin HDPE | 85 | 3700 | 3700 | 0.6 | 0.6 | 790 | 2.9 | 0.81 | c |
| High Metals | Virgin HDPE | 90 | 2200 | 2600 | 0.3 | 4.5 | 820 | 0.8 | 0.92 | c |
| High Metals | Recycle HDPE | 50 | 3600 | 3600 | 0.8 | 1.0 | 1700 | 3.9 | 1.82 | c |
| High Metals | Recycle HDPE | 80 | 3700 | 3700 | 1.2 | 1.2 | 620 | 4.1 | 1.00 | c |
| High Metals | Recycle HDPE | 85 | 3400 | 3400 | 0.5 | 0.5 | 940 | 1.6 | 0.84 | c |
| High Metals | Recycle HDPE | 90 | 4600 | 4600 | 0.6 | 0.6 | 1290 | 2.6 | 1.04 | c |
| High Metals | Recycle TPO* | 50 | 1900 | 1900 | 2.5 | 4.8 | 220 | 10.2 | 2.28 | h |
| High Metals | Recycle TPO* | 80 | 1300 | 1300 | 0.6 | 0.6 | 240 | 1.0 | 0.78 | c |
| High Metals | Recycle TPO* | 85 | 900 | 160 | 0.0 | 0.0 | 0 | 1.0 | 0.72 | c |
| High Metals | Recycle TPO* | 90 | **** | **** | **** | **** | **** | **** | 1.18 | c |
| High Metals | Recycle TPO** | 50 | 2100 | 2000 | 3.9 | 4.9 | 210 | 11.1 | 0.85 | c |
| High Metals | Recycle TPO** | 80 | 1700 | 1700 | 0.9 | 1.0 | 340 | 1.7 | 0.74 | c |
| High Metals | Recycle TPO** | 85 | 1500 | 1500 | 0.6 | 0.6 | 260 | 0.8 | 0.96 | c |
| High Metals | Recycle TPO** | 90 | 1100 | 20 | 14.2 | 14.6 | 4 | 1.5 | 0.78 | c |
| High Metals | Recycle ABS | 50 | 3100 | 3100 | 0.9 | 0.9 | 500 | 2.8 | 0.67 | c |
| High Metals | Recycle ABS | 80 | 2200 | 60 | 0.0 | 0.0 | 0 | 0.6 | 8.70 | c |
| High Metals | Recycle ABS | 85 | **** | **** | **** | **** | **** | **** | 0.92 | c |
| High Metals | Recycle ABS | 90 | **** | **** | **** | **** | **** | **** | **** | **** |
| High Metals | Recycle PVB | 50 | 1000 | 1000 | 113.4 | 113.4 | 3 | 107.5 | 11.97 | h |
| High Metals | Recycle PVB | 80 | 1200 | 1000 | 11.4 | 17.3 | 24 | 23.1 | 3.06 | h |
| High Metals | Recycle PVB | 85 | 1500 | 1000 | 9.0 | 20.5 | 38 | 39.6 | 3.43 | c |
| High Metals | Recycle PVB | 90 | **** | **** | **** | **** | **** | **** | 1.82 | c |
| High Metals | Commingled^{a} | 80 | 2800 | 2800 | 0.6 | 0.6 | 640 | 1.7 | 0.67 | c |
| High Metals | Commingled with | 80 | 3000 | 3000 | 1.0 | 1.1 | 520 | 3.3 | 0.70 | c |
| | Compatibilizer^{b} | | | | | | | | | |

*Paint,
**No Paint.
***Fracture mode results detail C complete break, H hinge break, NB no break, N/A Not applicable.
****Salnple too viscous to mold to test specifications. A 70% PE, 18% PS, 6% PP, 5% PMMA, 1% PVC, b 70% PE, 18% PS, 6% PP, 5% PMMA, 1% PVC = 100% model municipal waste. Then add 5% maleated S-EB-S (Kraton ® FG-1901X).

HDPE recycle and virgin proved to be good matrix for the high metallic fines. The composites could readily be used to mold parts. In fact, this stream was the one chosen to establish the efficacy of various processing techniques.

TPO recycle was an effective matrix but produced composites with very high viscosity at high metals loadings. This high viscosity meant that some test coupons could not be compression molded. ABS binder similarly produced composites that were even more viscous and the poor moldability was even more pronounced than with, for instance, TPO. Alternative ABS resins may reduce this effect.

PVB was an excellent binder for the high metallic fines. Simple blocks could be compression molded from high composition metallic fines composites. These proved to have very interesting properties. The test coupons had good elongation (20% elongation at 85% metals loadings) and impact properties (3.43 ft.lb/in at 85% loadings). This material may have added benefits beyond simply being a weighty composite.

The model commingled plastics binder proved to be a fairly poor binder. The addition of 5% by weight of ma-S-EB-S improved the mechanical properties. These proof-of-concept experiments confirm the addition of this compatibilizer would be beneficial when producing parts a commingled municipal waste steams as matrix material.

Compatibilization has been accomplished here by the incorporation of a block copolymer. This specific example of copolymer comprises three blocks where each is compatible with one component of the blend and incompatible with the other. A-x-B-x-A block copolymer, where A and B are long sequences of and identical to the corresponding A and B plastics forming the blend and x is a bond between the blocks, is a simple form of compatibilizer. A compatibilizer can be used to modify the morphology and the interfacial adhesion of a blend. For example, a compatibilizer may be used to reduce the interfacial tension between two phases which leads to a finer dispersion of one phase in the other, to enhance the adhesion between the phases by residing at the interface and providing a mechanism by which the two phases are chemically knitted together, and to stabilize the dispersed phase against coalescence.

Only the major interface in a multi-component plastic blend requires effective compatibilization to improve mechanical properties. That interface is between HDPE and PS in the model municipal waste stream used here.

The ferrous initiated degradation of polypropylene compounds often reported in the scientific literature was not seen during the limited time of these experiments.

Vibration Dampening

PVB is reported to have good sound and mechanical vibration damping properties. DMA data were determined on the PVB by itself, 75/25 PVB/low metallics, and 50/50 PVB/low metallics to learn if damping properties were greatly changed by the low metallics. The key DMA data are tabulated in Table 8. These results, as expected, show that Tg and modulus increase with increased loadings of low metallics. Tan δ is a measure of vibration damping, the higher the number the better the damping. Good damping materials have a relatively high Tan δ of >0.2 over the temperature range of use. PVB is a good damping material with a high Tan δ of 1.2. The low metallics filled PVB still has a relatively high Tan δ and should provide good damping properties.

TABLE 8
DMA analysis of PVB/Low Metallics composites

| Blend | | | |
|---|---|---|---|
| Composition (% w/w) | Tg | Storage Modulus | |
| PVB/Low metallics | (° C.) | (MPa) at 22.13° C. | Max Tan δ - Temp |
| 100/0 | 18.3 | 214 | 1.191 @ 34° C. |
| 75/25 | 21.5 | 611 | 1.107 @ 37° C. |
| 50/50 | 27.4 | 1051 | 0.759 @ 41° C. |

Similar experiments were performed on a single high metallics blend comprising 80% fines and 20% PVB recycle. This is a considerably higher fines content than could be achieved using the low metallics stream. Results for this composite are shown in Table 9. When the relatively low quantity of PVB in this blend is considered, the dampening factor of this composite is phenomenal. Further, this blend has a density of 3.43 g/cm³ and can be hand-molded (bent) into required geometries. This is a very interesting composite that may have intriguing application possibilities.

TABLE 9
DMA analysis of PVB/Low Metallics composites

| Blend | | | |
|---|---|---|---|
| Composition (% w/w) | Tg | Storage Modulus | |
| PVB/High metallics | (° C.) | (MPa) at 22.13° C. | Max Tan δ - Temp |
| 100/0 | 18.3 | 214 | 1.191 @ 34° C. |
| 20/80 | 19.1 | 1238 | 0.661 @ 34° C. |

Density

An approximation of composite density was established by weighing a bar and then measuring displacement when immersed in a small graduated cylinder of isopropanol. Density results have been reported in Tables 10-21. The densities recorded with low metallics composites were approximately 1.5 g/cm³ and up to 3.6 g/cm³ for the high metallics fines.

TABLE 10
Mixing history, density and composition of recycled
PVB/low metallic fines composites

| Blend Composition (% w/w) | Temp. after 10 | Torque after 10 | Density |
|---|---|---|---|
| r-PVB/Low metallics | minutes (° C.) | minutes (Nm) | (g/cm³) |
| 100/0 | 175 | 10.8 | 1.07 |
| 85/15 | 181 | 13.1 | 1.15 |
| 75/25 | 177 | 18.4 | 1.20 |
| 65/35 | 175 | 23.7 | 1.30 |
| 50/50 | 177 | 32.9 | 1.36 |
| 33/67 | 180 | 51.2 | — |

TABLE 11
Mixing history, density and composition of
recycled HDPE/low metallic fines composites

| Blend Composition (% w/w) | Temp. after 10 | Torque after 10 | Density |
|---|---|---|---|
| r-HDPE/Low metallics | minutes (° C.) | minutes (Nm) | (g/cm³) |
| 100/0 | 222 | 4.3 | 1.00 |
| 75/25 | 193 | 5.6 | 1.10 |
| 50/50 | 207 | 9.8 | 1.25 |
| 25/75 | 192 | 15.2 | 1.44 |
| 20/80 | 193 | 6.7 | 1.55 |
| 15/85 | 196 | 4.3 | 1.68 |

TABLE 12
Mixing history, density and composition of
virgin HDPE/low metallic fines composites

| Blend Composition (% w/w) | Temp. after 10 | Torque after 10 | Density |
|---|---|---|---|
| HDPE/Low metallics | minutes (° C.) | minutes (Nm) | (g/cm³) |
| 100/0 | 187 | 4.8 | 0.98 |
| 75/25 | 187 | 4.8 | 1.07 |
| 50/50 | 186 | 8.1 | 1.27 |
| 25/75 | 187 | 4.0 | 1.45 |
| 20/80 | 186 | 4.1 | 1.51 |

TABLE 13
Mixing history, density and composition of recycle,
painted TPO/low metallic fines composites

| Blend Composition (% w/w) | Temp. after 10 | Torque after 10 | Density |
|---|---|---|---|
| Rp-TPO/Low metallics | minutes (° C.) | minutes (Nm) | (g/cm³) |
| 100/0 | 194 | 4.7 | 0.95 |
| 75/25 | 192 | 5.4 | 1.06 |
| 50/50 | 191 | 6.8 | 1.24 |
| 25/75 | 192 | 9.3 | 1.47 |
| 20/80 | 193 | 7.3 | 1.50 |

TABLE 14
Mixing history, density and composition of recycle,
paint-free TPO/low metallic fines composites

| Blend Composition (% w/w) | Temp. after 10 | Torque after 10 | Density |
|---|---|---|---|
| r-TPO/Low metallics | minutes (° C.) | minutes (Nm) | (g/cm³) |
| 100/0 | 189 | 6.5 | 0.92 |
| 75/25 | 188 | 7.4 | 1.08 |
| 50/50 | 186 | 8.9 | 1.22 |
| 25/75 | 182 | 12.3 | 1.40 |
| 20/80 | 186 | 12.8 | 1.58 |

TABLE 15
Mixing history, density and composition of
recycle PVB/high metallic fines composites

| Blend Composition (% w/w) | Temp. after 10 | Torque after 10 | Density |
|---|---|---|---|
| r-PVB/High metallics | minutes (° C.) | minutes (Nm) | (g/cm³) |
| 100/0 | 175 | 10.8 | 1.07 |
| 50/50 | 182 | 9.1 | 1.85 |
| 20/80 | 177 | 12.2 | 2.98 |
| 15/85 | 181 | 11.1 | 3.25 |
| 10/90 | 180 | 12.7 | 3.43 |

TABLE 16
Mixing history, density and composition of recycle HDPE/high
metallic fines composites

| Blend Composition (% w/w) | Temp. after 10 | Torque after 10 | Density |
|---|---|---|---|
| r-HDPE/High metallics | minutes (° C.) | minutes (Nm) | (g/cm³) |
| 100/0 | 222 | 4.3 | 1.00 |
| 50/50 | 184 | 6.0 | 1.67 |
| 20/80 | 183 | 8.2 | 2.74 |
| 15/85 | 180 | 13.7 | 2.73 |
| 10/90 | 182 | 10.3 | 3.04 |

TABLE 17
Mixing history, density and composition of virgin HDPE/high
metallic fines composites

| Blend Composition (% w/w) | Temp. after 10 | Torque after 10 | Density |
|---|---|---|---|
| HDPE/High metallics | minutes (° C.) | minutes (Nm) | (g/cm³) |
| 100/0 | 187 | 4.8 | 0.98 |
| 50/50 | 189 | 5.1 | 1.59 |
| 20/80 | 185 | 7.4 | 2.46 |
| 15/85 | 183 | 11.4 | 2.77 |
| 10/90 | 179 | 27.9 | 3.18 |

TABLE 18
Mixing history, density and composition of recycle, painted TPO/high
metallic fines composites

| Blend Composition (% w/w) | Temp. after 10 | Torque after 10 | Density |
|---|---|---|---|
| Rp-TPO/High metallics | minutes (° C.) | minutes (Nm) | (g/cm³) |
| 100/0 | 194 | 4.7 | 0.95 |
| 50/50 | 185 | 4.3 | 1.64 |
| 20/80 | 185 | 4.2 | 2.79 |
| 15/85 | 183 | 4.8 | 3.02 |
| 10/90 | 185 | 4.9 | 3.37 |

TABLE 19
Mixing history, density and composition of recycle, paint-free
TPO/high metallic fines composites

| Blend Composition (% w/w) | Temp. after 10 | Torque after 10 | Density |
|---|---|---|---|
| r-TPO/High metallics | minutes (° C.) | minutes (Nm) | (g/cm³) |
| 100/0 | 189 | 6.5 | 0.92 |
| 50/50 | 185 | 5.3 | 1.61 |
| 20/80 | 184 | 5.8 | 2.67 |
| 15/85 | 184 | 5.5 | 3.16 |
| 10/90 | 184 | 5.1 | 3.40 |

TABLE 20
Mixing history, density and composition of recycle, ignition-resistant
ABS/high metallic fines composites

| Blend Composition (% w/w) | Temp. after 10 | Torque after 10 | Density |
|---|---|---|---|
| r-ir ABS/High metallics | minutes (° C.) | minutes (Nm) | (g/cm³) |
| 100/0 | 185 | 8.0 | 1.22 |
| 50/50 | 184 | 7.5 | 1.94 |
| 20/80 | 182 | 10.9 | 3.03 |
| 15/85 | 182 | 12.3 | 3.31 |
| 10/90 | 182 | 11.9 | 3.57 |

TABLE 21
Mixing history, density and composition of commingled
model municipal waste/high metallic fines composites with
and without a compatibilizing agent

| Blend Composition (% w/w) | | | |
|---|---|---|---|
| Commingled model | | | |
| municipal waste blends | Temp. after 10 | Torque after 10 | Density |
| High metallics | minutes (° C.) | minutes (Nm) | (g/cm³) |
| 20/80 | 181 | 9.5 | 2.68 |
| 20/80 with compatibilizer | 180 | 10.7 | 2.73 |

Initial goals of producing weighty composites that can effectively compete with incumbent materials have been accomplished. These composites have densities up to 160% that of concrete (about half that of steel).

Extrusion, pelletizing and parts production (compression molding, injection molding and sheet extrusion) test of the composites all proved successful.

Extruding and Pelletizing

A 1¼″ single screw Killion Extruder, Inc. Model 11670 extruder with an L/D ratio of 30:1 was used to extrude a number of samples. 50/50 w/w and 75/25 w/w blends were produced from a magnetically separated metallic component and virgin HDPE. The metallic component was size filtered to only use those metals less than 60 mesh (250 microns). The virgin HDPE used was a powdered type rather than pelletized. These two materials were combined to ensure adequate mixing in the single screw extruder. An antioxidant, Irganox B225 from Ciba, was also added. The compositions used are recorded in Table 22.

TABLE 22
Composition of blends extruded and pelletized in
proof-of-concept experiments

| Composition | Metals (g) | Resin (g) | Antioxidant (g) |
|---|---|---|---|
| 50/50 | 615 | 615 | 1.2 |
| 50/50 | 762 | 762 | 1.4 |
| 75/25 | 1500 | 500 | 1 |

The temperature controls for the 1¼″ single screw Killioin Extruder, Inc. Model 11670 extruder set 5 regions in the barrel. The temperature was set at 400° F. (205° C.) in each region for the 50/50 w/w composition blend.

The recorded temperature for each region, starting from the hopper and ending at the extrusion die, was 398, 436, 414, 403 and 411° F. (203, 224, 212, 206 and 211° C.). The screw was set at a constant rotation of 70 rpm and allowed to draw as much power as needed. The drawn power is a measure of the blend viscosity although a direct correlation is not available from this older production unit. Th 50/50 w/w HDPE blend drew 9 amps and the 75/25 w/w HDPE blend drew 15 amps on a first pass and 12 amps on a second pass (after the blend had been partially homogenized). The density of this composite was 1.63 g/cm³.

The temperature was set at 400° F. (205° C.) for the first region and 450° F. (232° C.) in each subsequent region for the 75/25 w/w composition blend. The temperature was kept lower in the first section to help promote movement of the extrudate through the barrel due to the increased pressure caused by the higher solids concentration. The recorded temperature for each region starting from the hopper and ending at the extrusion die, was 396, 482, 458, 455 and 454° F. (202, 250, 237, 235 and 234° C.). The power drawn for the single run performed at 80 rpm was 18 amps. The density of this composite was 2.73 g/cm³.

The strands were cooled in a Berlyn water bath and pelletized using a Conair Jetro Model 304 pelletizer.

Loadings of 75% w/w high metallics foundry waste were difficult to strand from the extruder due to poor melt strength. Die face cutting would be a preferred pelletizing approach for these highly loaded high metallics foundry waste blends. Further, loss-in-weight feeding technology, metering high metallics foundry waste into the melt, would be preferred for compounding highly filled HDPE. The high metallics foundry waste particle size should be restricted to less than 60 mesh to reduce wear and possible seizing between screw and barrel. Wear resistant barrel and screw elements should be considered for continuous compounding of these blends.

Compression Molding

A Pasadena Hydraulics, Inc. compression molding press was used to produce tensile bars. The samples were admitted to a press that was pre-heated to 400° F. (205° C.). Sufficient time, often 10-20 minutes, was allowed for the mold to come up to temperature and for the material to soften before applying the clamping pressure of up to 20,000 pounds ram force. Once pressed, the molds were held under pressure during the slow cool-down period that was typically 5-10 minutes long. The samples produced by this technique were of good quality. This technique has been used on compositions of up to 93% w/w of high metallics.

Injection Molding

The 50/50 w/w and 75/25 w/w pellets were injection molded using a Boy 30T2 injection molding machine. The samples produced in these proof-of-concept experiments were excellent in quality with the molds being fully filled.

Injection molding the 75/25 blend required full injection pressure to fill the mold. Higher loadings of high metallics foundry waste may be difficult to injection mold with standard reciprocating screw equipment. Hardened screw, barrel, and mold cavities may be required for these highly loaded blends.

Sheet Extrusion

A 1″ single screw Killion Extruder, Inc. Model 110 extruder with an L/D ratio of 24:1 was used to extrude a number of samples through a 2″ taper sheet die. The screw was rotated at 54 rpm to allow a steady extrudate to fall on a cooling conveyer belt. The sheet produced using the 50:50 w/w blend was excellent in quality. The sheet produced using the 75:25 w/w blend was good but had some evidence of alligator skin deformation. This appearance is attributed to the 75:25 w/w pellets retaining more moisture and given time anticipate that an improved sheet appearance could be achieved.

The above description is considered that of the preferred embodiments only. Modifications of the invention will occur to those skilled in the art and to those who make or use the invention. Therefore, it is understood that the embodiments described above are merely for illustrative purposes and not intended to limit the scope of the invention, which is defined by the following claims as interpreted according to the principles of patent law, including the doctrine of equivalents.

The invention claimed is:

1. An article formed from a composite material comprising:
a polymeric matrix; and
foundry waste fines dispersed throughout the polymeric matrix.

2. The article of claim 1, wherein the waste fines comprise particles having a size less than 250 microns.

3. The article of claim 1, wherein the polymer matrix comprises a thermoplastic olefin.

4. The article of claim 1, wherein the polymer matrix comprises high density polyethylene.

5. The article of claim 1, wherein the polymer matrix comprises a recycled polymeric material.

6. The article of claim 1, wherein the polymer matrix comprises a recycled polymeric material selected from the group consisting of thermoplastic olefins, polyvinylbutyral, polystyrene, polyvinylchloride, and polymethylmethacrylate.

7. The article of claim 5, wherein the polymer matrix is composed primarily of recycled polymeric material.

8. The article of claim 1, wherein the foundry waste fines comprise from about 50% to about 95% of the weight of the composite material.

9. The article of claim 1, wherein the article is a counter-weight on a file cabinet, which prevents the cabinet from tipping when a weighted top drawn is open.

10. The article of claim 1, wherein the composite material has a density greater than two times the density of the polymeric matrix.

11. The article of claim 1, wherein the waste fines comprise the high metals component of a magnetic separation process.

12. The composite of claim 1, wherein the matrix is a thermoset material.

13. The composite of claim 1, wherein the waste fines impart electrical conductivity to the composite.

14. A composite material comprising:
a polymeric matrix; and
foundry waste fines dispersed throughout the polymeric matrix.

15. The composite of claim 14, wherein the waste fines comprise particles having a size less than 250 microns.

16. The composite of claim 14, wherein the polymer matrix comprises a thermoplastic olefin.

17. The composite of claim 14, wherein the polymer matrix comprises high density polyethylene.

18. The composite of claim 14, wherein the polymer matrix comprises a recycled polymeric material.

19. The composite of claim 14, wherein the polymer matrix comprises a recycled polymeric material selected from the group consisting of thermoplastic olefins, polyvinylbutyral, polystyrene, polyvinylchloride, and polymethylmethacrylate.

20. The composite of claim 14, wherein the polymer matrix is composed primarily of recycled polymeric material.

21. The composite of claim 14, wherein the foundry waste fines comprise from about 50% to about 95% of the weight of the composite material.

22. The composite of claim 14, wherein the composite material has a density greater than two times the density of the polymeric matrix.

23. The composite of claim 14, wherein the waste fines comprise the high metals component of a magnetic separation process.

24. The composite of claim 14, wherein the matrix is a thermoset material.

25. The composite of claim 14, wherein the waste fines impart electrical conductivity to the composite.
